(19) United States
(12) Patent Application Publication
(10) Pub. No.: US 2014/0130650 A1
(43) Pub. Date: May 15, 2014

(54) ROLLER PUNCH WITH REMOVABLE HEAD

(71) Applicant: Tavnir J. Carey, West Jordan, UT (US)

(72) Inventor: Tavnir J. Carey, West Jordan, UT (US)

(21) Appl. No.: 13/675,379

(22) Filed: Nov. 13, 2012

(51) Int. Cl. B26F 1/32

(52) U.S. Cl. CPC B26F 1/32
USPC 83/30; 30/365

(57) ABSTRACT

An apparatus creates evenly spaced holes or patterns in a consistent pattern on a sheet of paper or similar sheet. The apparatus includes a head with a rotatable cylinder and a handle that can be attached to the head. Upon the cylinder are a series of spikes or patterns. When the cylinder is rolled along the sheet, the spikes or pattern create a precise and consistent pattern of holes in the sheet. The head can be easily detached from the handle and a different head having a different spike pattern can be mated to the head so that differing holes patterns can be easily created.

### BACKGROUND OF THE INVENTION

1. The Field of the Invention

The present invention relates to a roller punch device and system that allows attachment of various heads to create differing patterns.

2. The Relevant Technology

A popular technique for adding embellishment and detail to the pages of scrapbooks, invitations, and similar pages is to create stitching by piercing holes in the page and threading a string or line through the holes. The holes can be created in unique patterns and with varying spacing between holes. Additionally, a wide variety of materials and variation can be used for the line, allowing for the stitching technique to produce a wide variety of styles, looks, and effects.

Currently two primary techniques are used to create the stitching effect, hand stitching and a sewing machine. Both have disadvantages. Hand stitching requires the user to manually create each hole with a needle or sharpened end. This is time consuming because creating each individual hole requires a separate action. It is also difficult to achieve consistency in design and spacing of the holes when hand stitching. Use of a sewing machine is much faster than hand stitching and can create consistently spaced holes, but a sewing machine is heavy and cumbersome. The user must either carry the sewing machine to the location of the project or bring the project materials to the sewing machine. A sewing machine requires a power source and is an expensive tool. Additionally, feeding the sheets through the sewing machine may be awkward or difficult if sheets are bound in a book or attached to other sheets or materials. Further, in order to create holes in a particular pattern, the sheet must be constantly manipulated and oriented in relation to the needle as the sheet is fed to the sewing machine.

For the foregoing reasons, there is a need for a method or apparatus that can quickly create stitching holes, maintain consistency in spacing and pattern, and do so without requiring cumbersome machinery or requiring difficult manipulation of the material or sheets to be stitched. Further, an apparatus is needed that can easily create stitching holes in different patterns.

### BRIEF SUMMARY

The present invention is directed to an apparatus and method that satisfies the need of quickly creating stitch holes that are consistently spaced and in a consistent pattern without requiring cumbersome equipment or undue manipulation of the sheets.

One aspect of the present invention is directed to a stitch piercer. The stitch piercer comprises a handle and a head. The head comprises a cylindroid that is rotatably mounted on an axle. At least one spike is attached to the curved face of the cylindroid. The head may be attached to the handle.

In another aspect of the invention, the cylindroid may optionally have multiple spikes attached to its curved face. The spikes may be arranged according to both a specific spacing interval or based upon a specific design pattern.

In another aspect of the invention the head optionally is removably attached to the handle. The head has a post extending from it. This post can be inserted into a bore or hole within the handle, so that the head becomes firmly mated to the handle. To assist in maintaining the directional orientation of the head with that of the handle, the post may have a nub that corresponds in size with groove placed along the bore inside the handle. The nubs align with the grooves and create directional stability.

In another aspect of the invention, heads with different and unique spike patterns may be attached to the handle, each head producing a different stitching effect.

In another aspect of the invention, the head includes a cylindroid with at least one spike attached to its circular face. An axle intersects the cylindroid and is parallel with the circular face of the cylindroid so that the cylindroid can be rolled along another surface. A housing includes two axle mounting plates that act to secure each end of the axle to the rest of the head and a bridge that connects the two axle mounting plates together so that the housing provides structural reinforcement to the head.

In another aspect of the invention, a user grasps the handle and aligns the head, specifically the cylindroid portion of the head, upon a surface, such as a sheet of paper. By applying pressure downward, the user causes the spike on the cylindroid to pierce the sheet and create a hole. Then, maintaining downward pressure, the user applies forward pressure to the handle. This pressure causes the cylindroid to roll along the sheet and each time the spike encounters the sheet, a new hole is formed at an interval equal to the circumference of the cylindroid.

In another aspect of the invention, the cylindroid has multiple spikes. The spikes are arranged with distinct spacing and in a distinct relation to one another so that as pressure is applied and the cylindroid is rolled along a sheet, the multiple spikes create holes in a distinct repeating pattern. Some examples of the pattern include loops, waves, crosses, flowers, and hearts.

The previously described aspects of the invention have many advantages, including inexpensive cost, easy of use, portability, the ability to create holes quickly, the ability to create holes with consistent spacing, the ability to create holes in a particular pattern, and the option of changing the pattern and variation of holes through interchangeable heads.

The invention need not have a motor or power source. It need not be manufactured from rare or expensive materials. As a consequence, it should be inexpensive to manufacture when compared to powered sewing machines.

It is not necessary for all embodiments of the invention to have all the advantages of the invention or fulfill all the purposes of the invention.

### BRIEF DESCRIPTION OF THE DRAWINGS

Various embodiments of the present invention are shown and described in reference to the numbered drawings wherein:

FIG. 1 shows a perspective view of the rotary stitch piercer;

FIG. 2 shows a side view of the rotary stitch piercer;

FIG. 3 shows a top view of the rotary stitch piercer;

FIG. 4 shows a bottom view of the rotary stitch piercer;

FIG. 5 shows a rear view of the rotary stitch piercer;

FIG. 6 shows a front view of the rotary stitch piercer;

FIGS. 7A, 7B, and 7C illustrate a series of perspective views of the rotary stitch piercer with a head being attached to a handle;

FIG. 8 shows a perspective view of the head;

FIG. 9. shows a detailed perspective view of the handle; and

FIG. 10. shows a perspective side view of the head.

It will be appreciated that the drawings are illustrative and not limiting of the scope of the invention, which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

A device is used to create a pattern on medium. The devices creates evenly spaced holes in a consistent pattern or a pattern using a dye, such as ink, which is rolled onto a sheet of paper or similar sheet. The device includes a head with a rotatable cylinder and a handle that can be attached to the head. A series of spikes or raised patterns are disposed on the cylinder. When the cylinder is rolled along the sheet, the spikes or raised patterns create a precise and consistent design on the sheet. The head can be easily detached from the handle and a different head having a different spike pattern can be mated to the head so that differing holes patterns can be easily created.

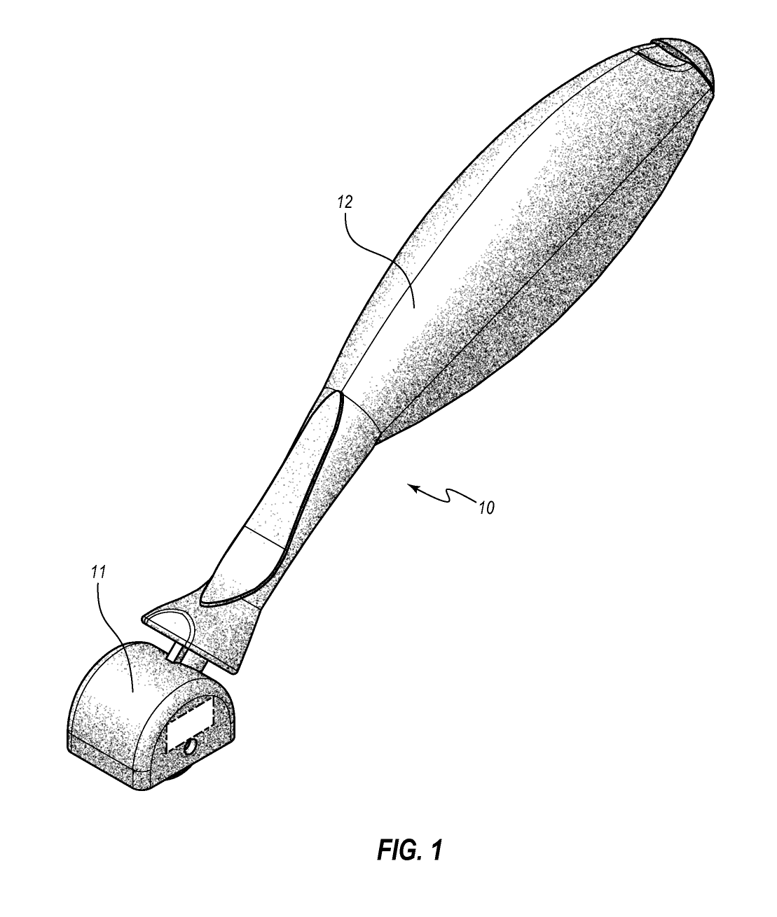

FIG. 1 is a perspective view of one embodiment of the device, such as a rotary stitch piercer, designated generally at 10. The head 11 may be connected to a handle 12. The head 11 may be removably attached to the handle 12 and may be snapped on and off of the handle 12 so that a wide variety of heads can be attached and used by the same handle. The rotary stitch piercer 10 may be comprised of a wide variety and combination of rigid materials, including plastic, metal, fiberglass, glass, polymer, carbon, wood, or any other material as deemed suitable by one skilled in the art.

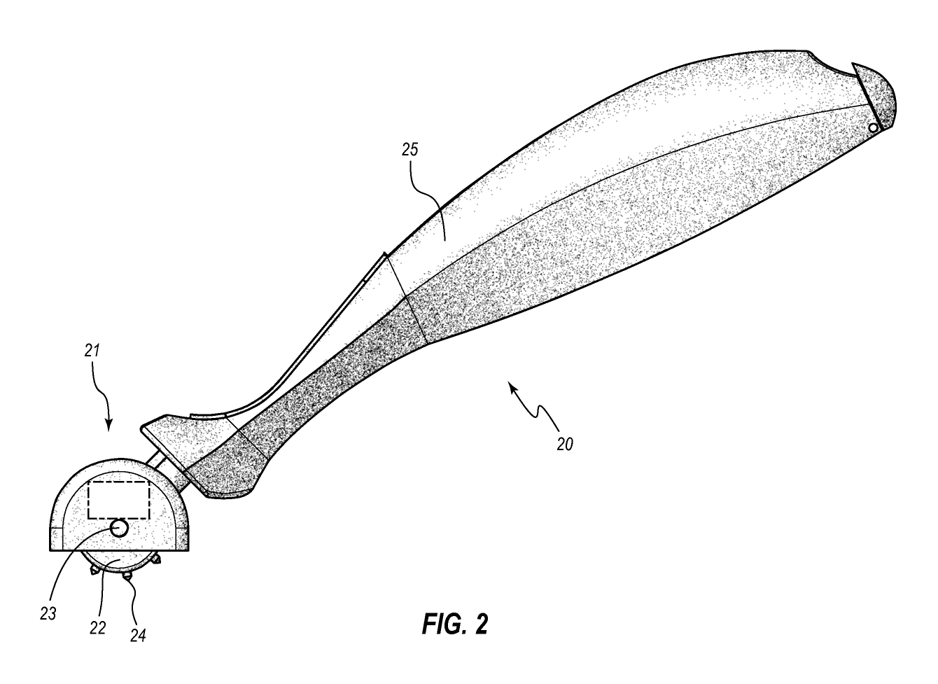

Referring now to FIG. 2, a side view of one embodiment of a rotary stitch piercer, designated generally at 20. A head, designated generally at 21 comprises a cylindroid 22 rotatably mounted on an axle 23. The cylindroid 22 is generally a cylinder, buy may be any shape with a curved face that allows the cylindroid 22 to roll along a surface. The cylindroid 22 has at least one and optionally multiple spikes 24 attached to it and arranged in a pattern. The head 21 may be attached to a handle 25 by a variety of mean, including snapping the head 21 into the handle 25, threading the head 21 to the handle 25, or bonding the head 21 and handle 25 by a bonding means such as Velcro, adhesive, magnets, screws, bolt and nut, or similar means.

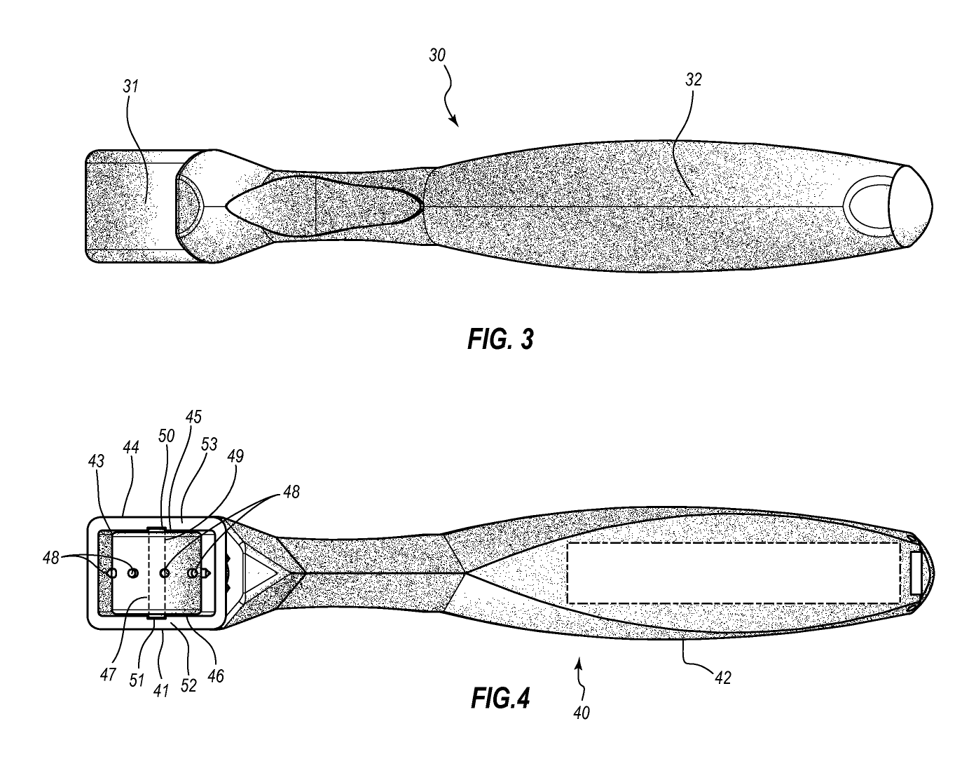

FIG. 3 is a top view of one embodiment of a rotary stitch piercer, designated generally at 30. A head 31 links to a handle 32.

Referring now to FIG. 4, a bottom view of one embodiment of a rotary stitch piercer, designated generally at 40. A head 41 may be attached to a handle 42. The head 41 may comprise a cylindroid, shown generally at 43 and a housing 44. The cylindroid 43 comprises a first planar face 45 and a second planar face 46 connected by a continuous circular face 47. The continuous circular face 47 may have a spike 48 attached to it. Alternatively, the continuous circular face 47 may have multiple spikes 48 arranged in a variety of intervals in designs. The cylindroid may have a rotatable axle 49 intersecting through it with a first axle end 50 and second axle end 51 extending from the cylindroid 43. The first axle end 50 may be mounted to a first mounting plate 52 and the second axle end 51 may be mounted to a second mounting plate 53. The housing 44 may serve as a bridge to connect the two mounting plates.

Referring now to FIG. 5, a back view of one embodiment of a rotary stitch piercer, designated generally at 55.

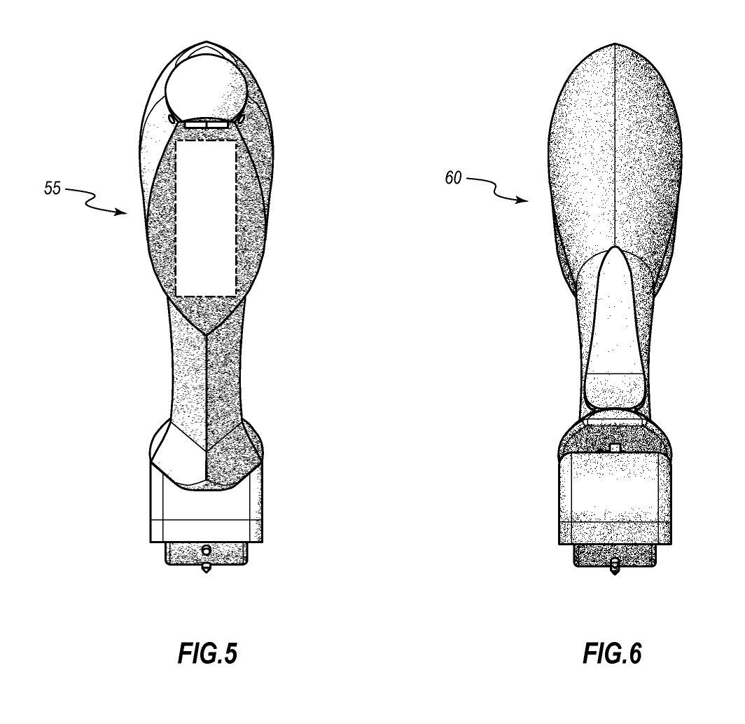

Referring now to FIG. 6, a front view of one embodiment of a rotary stitch piercer, designated generally at 60.

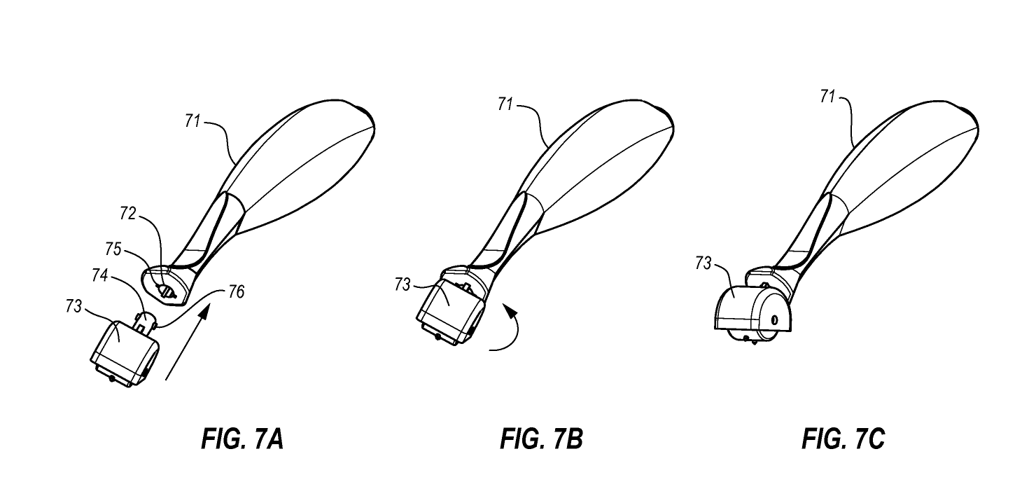

FIGS. 7A, 7B and 7C illustrate an embodiment of a rotary stitch piercer in the process of changing heads. A handle 71 may have a hollow bore 72. The head 73 may have a post 74 of roughly equivalent or slightly smaller size than the bore 72, so that the post 74 may fit inside the bore 72. The hollow bore 72 may have one or alternatively several grooves 75 along its wall and the post may have one or alternatively several nubs 76 which align with the grooves 75. The head 73 may be attached and removed from the handle 71 by inserting the post 74 into the bore 72. Once the post 74 is inserted into the bore 72, the head 73 may be rotated so that the head 73 snaps into alignment and the head 73 then becomes firmly mated to the handle 71.

To use the rotary stitch piercer in the various embodiments, the user grasps the handle. The head is removably attached to the handle, which includes rotatable cylindroids. The rotatable cylindroid of the head has a surface and at least one spike disposed on the surface. The user aligns the rotatable cylindroid upon a material, such as a sheet of paper, cardstock, paper vellum and the like. The user then applies a downward and forward pressure to the handle rotating the cylindroid and rolling it along the material. The spike or series of spikes pierce the material to create a hole or a pattern of holes in the material.

The user can also roll the rotatable cylindroid along the material continuously for a distance greater than the circumference of the cylindroid to create a pattern based on the spacing and positions of the spikes. The spike or spikes puncture a pattern of holes in the material as the at least one spike repeatedly punctures the material.

The user may vary the pattern of the stitch piercer by removing the head from the handle and selecting a new head. The new head may have a distinct arrangement of spikes affixed to the rotatable cylindroids. The user aligns the connectable post with the handle and attaches the new head with a connecting socket. The connecting socket is attached to the handle. The user then slides the connecting post into the connecting socket. The new head mates with the handle.

A nub on the connecting post may be aligned with a groove within the connecting socket to connect the head to the handle. The nub isolates the orientation of the new head with the orientation of the groove. The user may also align the nub on the connecting post with a groove within the connecting socket. The location of the nub and the groove may be arranged to cause the head to be misaligned with the handle when the nub and the groove are aligned. The user then slides the connecting post into the connecting socket. The head is rotated to cause the nub to slide along a recessed groove. The recessed grove is connected to and perpendicular to the groove. The rotation causes the head to align with the handle and the connecting post to be mated with the handle.

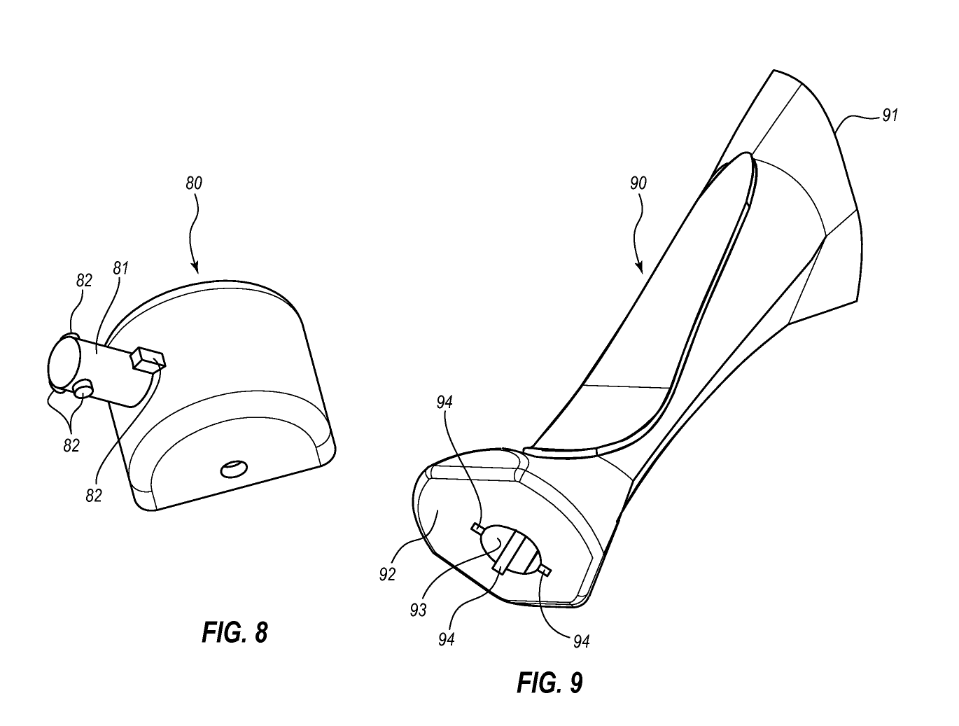

Referring now to FIG. 8, showing one embodiment of a head, designated generally at 80. A post 81 may be attached to the head 80. One or alternatively several nubs 82 may be affixed or alternatively protrude from the post. The post 81 preferably is round, but my be a different shape, so long as that shape is consistent with the shape of the hollow bore FIG. 9, 93.

Referring now to FIG. 9, showing one embodiment of a handle, designated generally at 90. The handle may have a top end 91 and a bottom end 92. Within the handle there may be a hollow bore 93. Along the inside walls of the bore 93 may be a groove 94 or alternatively many grooves 94. The groove 94 may be of a similar circumference to the post FIG. 8, 81 so that the post FIG. 8, 81 fits snugly into the hollow bore 93 so that there is adequate friction to keep the head FIG. 8, 80 from falling away from the handle 90 unless a minimal force is applied. Preferably the force necessary to remove the post FIG. 8, 81 from the bore 93 is greater than the force applied to the head FIG. 8, 80 by gravity, but not so great as to inhibit a person of below average strength from easily pulling the post FIG. 8, 81 from the bore 93. The groove 94 may be of approximately the same size as the nub FIG. 8, 82 so that when the post FIG. 8, 82 is inserted into the hollow bore 93, the nub FIG. 8, 82 fits snugly into the groove 94 and locks the handle 90 in the same directional orientation as the head FIG. 8, 80.

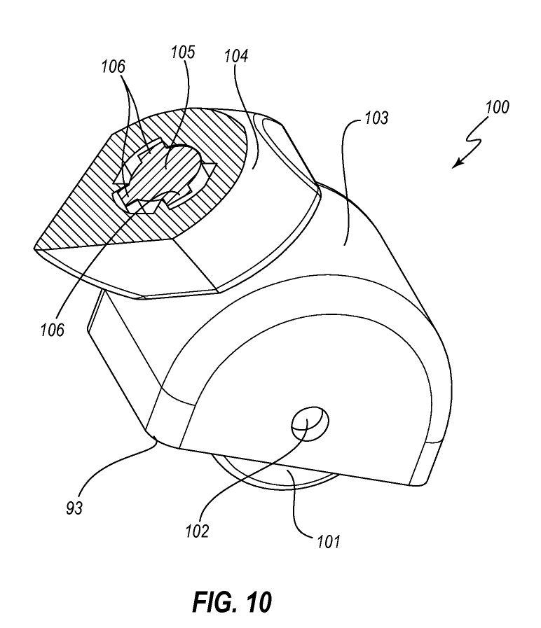

Referring now to FIG. 10, showing one embodiment of the head, designated generally at 100. The head 100 comprises a rotatable cylindroid 101 that may be mounted on an axle 102 and may be enclosed by a housing 103. A receptacle 104 may be attached to the housing 103. Within the receptacle 104, there may be a hollow bore 105 with one or alternatively many grooves 106, the hollow bore 105 being suitable for mating the head 100 to a handle or other device.

The device may be a stitch piercing apparatus or a ink rolling device for rolling a pattern on a medium, such as paper or card stock. The device may include a cylindroid member. The cylindroids member may include a first planar face, a second planar face, and a continuous circular face connecting the first planar face and the second planar face. At least one spike or a series of spikes, or a raised pattern may be attached to the continuous circular face. An axle intersects through the cylindroid member and is parallel to the continuous circular face. The axle may include a first axle end extending from the first planar face and a second axle end extending from the second planar face. A housing may include a first axle mounting plate pivotally attached to the first axle end, and a second axle mounting plate pivotally attached to the second axle end. A housing bridge may be attached to both the first axle mounting plate and the second axle mounting plate.

The device may include a head, including a cylindroid mounted on a rotatable axle, at least one spike attached on the cylinder, and a handle connected to the head. The head may further include multiple spikes attached in distinct patterns on the cylinder. The handle may be removably connected to the head to interchange heads with different patterns or styles.

An arm may be attached to the head, including a post extending from the head, and at least one nub affixed to the post. A handle may be removably attached to the arm, the handle having a shaft with a top end and a bottom end. A hollow bore may be disposed within the shaft, which is sized to attach the head to the handle. The bore may have an opening at the bottom end. At least one guidance groove may be disposed along the hollow bore originating at the bore opening, whereby the arm is inserted into the hollow bore and oriented so that the at least one guidance nub aligns with the at least one guidance groove and isolates the orientation of the head with the orientation of the handle. A recessed groove may be located within the hollow bore and attached continuously to the at least one guidance groove.

There is thus disclosed an improved rotary stitch piercer. It will be appreciated that numerous changes may be made to the present invention without departing from the scope of the claims.

What is claimed is:

1. A method for stitch piercing, comprising:
grasping a handle, the handle being removably attached to a head, the head comprising a rotatable cylindroid, the rotatable cylindroid having a surface and at least one spike disposed on the surface;
aligning the rotatable cylindroid upon a material; and
applying downward and forward pressure to the handle, the rotatable cylindroid being rolled along the material, the at least one spike piercing the material to create a hole.

2. The method of claim 1, further comprising a step of:
rolling the rotatable cylindroid along the material continuously for a distance greater than the circumference of the cylindroid, the at least one spike puncturing a pattern of holes in the material as the at least one spike repeatedly punctures the material.

3. The method of claim 2, further comprising the steps of:
removing the head from the handle;
selecting a new head, the new head having a distinct arrangement of spikes affixed to the rotatable cylindroid;
aligning a connectable post, the post being attached to the new head, with a connecting socket, the connecting socket being attached to the handle; and
sliding the connecting post into the connecting socket, the new head mating with the handle.

4. The method of claim 3, further comprising a step of:
aligning a nub on the connecting post with a groove within the connecting socket, the nub isolating the orientation of the new head with the orientation of the groove.

5. The method of claim 3, wherein the step of mating the new head with the handle further comprises:
aligning a nub on the connecting post with a groove within the connecting socket, the location of the nub and the groove so located as to cause the head to be misaligned with the handle when the nub and the groove are aligned;
sliding the connecting post into the connecting socket;
rotating the head, causing the nub to slide along a recessed groove, the recessed grove connected to and perpendicular to the groove, and causing the head to align with the handle and causing the connecting post to be mated with the handle.

6. An apparatus for stitch piercing, the apparatus comprising:
a cylindroid member, comprising:
a first planar face;
a second planar face;
a continuous circular face connecting the first planar face and the second planar face;
at least one of a spike and a raised pattern attached to the continuous circular face;
an axle intersecting through the cylindroid member and parallel to the continuous circular face, the axle comprising:
a first axle end extending from the first planar face; and
a second axle end extending from the second planar face;
a housing, the housing comprising:
a first axle mounting plate pivotally attached to the first axle end;
a second axle mounting plate pivotally attached to the second axle end; and
a housing bridge attached to both the first axle mounting plate and the second axle mounting plate.

7. An apparatus for stitch piercing, the apparatus comprising:
a head, the head comprising:
a cylindroid mounted on a rotatable axle;
at least one spike attached on the cylinder; and
a handle connected to the head.

8. The apparatus of claim 7, wherein the head further comprises multiple spikes attached in distinct patterns on the cylinder.

9. The apparatus of claim 7 wherein the handle is removably connected to the head.

10. The apparatus of claim 7, further comprising:
an arm attached to the head, the arm comprising:
a post extending from the head; and
at least one nub affixed to the post;
a handle removably attached to the arm, the handle comprising:
a shaft with a top end and a bottom end;
a hollow bore within the shaft, the bore having an opening at the bottom end;
at least one guidance groove along the hollow bore originating at the bore opening, whereby the arm is inserted into the hollow bore and oriented so that the at least one guidance nub aligns with the at least one guidance groove and isolates the orientation of the head with the orientation of the handle.

11. The apparatus of claim 10, further comprising:
a recessed groove located within the hollow bore and attached continuously to the at least one guidance groove.
